(19) United States
(12) Patent Application Publication
(10) Pub. No.: US 2018/0189703 A1
(43) Pub. Date: Jul. 5, 2018

(54) DIRECT MAIL HYBRID TRANSPORTATION ALLOCATION OPTIMIZATION SYSTEM AND METHOD

(71) Applicant: Mystic Logistics Holdings, LLC, South Glastonbury, CT (US)

(72) Inventors: Shaun Nicholson, Hebron, CT (US); Donald Lewis LaBarre, III, Avon, CT (US)

(21) Appl. No.: 15/852,734

(22) Filed: Dec. 22, 2017

Related U.S. Application Data
(60) Provisional application No. 62/440,565, filed on Dec. 30, 2016.

(51) Int. Cl. G06Q 10/06; G06Q 10/08; G06Q 30/02

(52) U.S. Cl. CPC G06Q 10/06313; G06Q 2250/50; G06Q 30/0283; G06Q 10/083

(57) ABSTRACT

A direct mail hybrid transportation allocation optimization system and method includes receiving at least one “as-marked” mail data file associated with at least one mail job having a plurality of mail pieces, wherein the mail data file includes as-marked data identifying a plurality of USPS destination entry locations for the plurality of mail pieces, each mail piece having a corresponding tray and a corresponding pallet, receiving a pricing scenario associated with transportation methods, including consolidation, co-palletization, and commingle, performing a hybrid transportation cost optimization which includes an iterative analysis based on the as-marked data and the pricing scenario, and generating a optimized transportation allocation data file, based on the hybrid cost optimization, the optimized transportation allocation data file includes data identifying optimized transport allocation, including at least one of consolidation mail services, co-palletization mail services or commingle mail services for each mail piece, tray or pallet.

### CROSS-REFERENCE TO RELATED APPLICATIONS

This application claims priority to U.S. Provisional Patent Application No. 62/440,565, filed Dec. 30, 2016, which is hereby incorporated by reference in its entirety.

### BACKGROUND

The process of traditional mailing is well known. A mailer deposits one or more mail pieces at a post office of the United States Postal Service (“USPS”) along with payment of the postage in an amount sufficient to cover the current postage rate applicable to each of the mail pieces. Then, the USPS delivers the mail pieces to their designated destination using its national network of transportation vehicles, distribution centers and post offices.

Different from traditional mailing, the USPS permits bulk or “direct” mailers having large amounts of mail pieces to deliver or “drop ship” bulk shipments of mail to various locations within the USPS's distribution network. The applicable postage rate per piece of mail contained in a bulk mailing shipment depends on where the bulk mailing shipment is delivered within the USPS's distribution network. If a mailer delivers a bulk mailing shipment “further down” the USPS's distribution network, in other words, to a location deeper within the USPS's specified mail flow network for the bulk shipment, then the applicable postage rate per piece of mail in the shipment will be less than if the mailer delivered the shipment “further up” the USPS's distribution network (i.e. to a location earlier within the USPS's specified mail flow for the bulk shipment), because there are less steps required for the USPS to deliver the bulk shipment. This is known as “drop shipping.”

Thus, the framework of the USPS's distribution network provides opportunities for mailers to logistically plan and/or perform their bulk mailing shipments in order to achieve postage rate savings. It also provides opportunities for third party vendors to provide logistics services for one or more mailers to reduce overall costs of delivering bulk mail shipments. However, given the USPS's complex distribution network mail flow scheme, the dynamically changing postage rates and variable costs associated with shipping bulk mail shipments to USPS locations and/or intermediate private vendor facilities, and the fluctuating requirements for mailers' bulk shipment jobs, the number of options available to a mailer at any given time for a given shipment are huge. Thus, it would be desirable to have a system or method that identifies the most desirable mailing/shipping approach.

### BRIEF DESCRIPTION OF THE DRAWINGS

FIG. 1 is a diagram of possible mail flow paths to and within the USPS distribution network, according to embodiments of the present disclosure.

FIG. 2 is a diagram of an exemplary direct mail hybrid cost optimization system, according to embodiments of the present disclosure.

FIG. 2A is a diagram of an exemplary direct mail hybrid cost optimization general process.

FIG. 3 is a flow diagram of an exemplary bulk mailing logistics method, according to embodiments of the present disclosure.

FIG. 4 is an illustration of an exemplary graphical user interface for entering data and displaying results, according to embodiments of the present the disclosure.

FIG. 5 is an exemplary consolidation service charges and rate sheet, according to embodiments of the present disclosure.

FIG. 6 is an exemplary co-palletization service charges and rate sheet, according to embodiments of the present disclosure.

FIG. 7A is a flow diagram of the hybrid analysis shown in FIG. 3, according to embodiments of the present disclosure.

FIG. 7B is a flow diagram of processing Mail.dat file(s) shown in FIG. 7A, according to embodiments of the present disclosure.

FIG. 7C is a flow diagram of the iterative analysis shown in FIG. 7A, according to embodiments of the present disclosure.

FIG. 7D is a flow diagram of determining the improved shipping method shown in FIG. 7C, according to embodiments of the present disclosure.

FIG. 8 is an exemplary report summary of an executed method, according to embodiments of the present disclosure.

FIG. 9 is another exemplary report summary of an executed method, according to embodiments of the present disclosure.

FIG. 10 is another exemplary report summary, according to embodiments of the present disclosure.

FIG. 11 is an illustration of a graphical user interface displaying results from a second example, according to embodiments of the present disclosure.

FIG. 12 is a diagram of USPS entry locations of FIG. 1 according to embodiments of the present disclosure.

FIG. 13 is a diagram of a pallet containing trays and the trays containing mail pieces according to embodiments of the present disclosure.

FIG. 14 is a partial view of an exemplary drop-ship file according to embodiments of the present disclosure.

FIG. 15 is an illustration of exemplary tray objects generated from data contained in one or more Mail.dat files according to embodiments of the present disclosure.

FIG. 16 is an illustration of an exemplary core qualified collection according to embodiments of the present disclosure.

FIG. 17A is a diagram depicting the generation of a Postage Rate Table based on a USPS Postal Notice 123 and a CQT record of a Mail.dat file that may be utilized by systems and methods according to embodiments of the present disclosure.

FIG. 17B is the Postage Rate Table of FIG. 17A according to embodiments of the present disclosure.

### DETAIL DESCRIPTION OF THE DRAWINGS

As described further herein, the present disclosure advantageously provides methods and systems that determine a shipping method (or transportation) allocation optimization for bulk/direct mailing jobs, that use an iterative data analysis technique and a comprehensive pricing scenario. Systems and methods according to the present disclosure allows for accurate cost estimations at the tray level.

The present disclosure advantageously provides systems and methods for reducing time spent with entry-assignment optimization software/services currently available. The present disclosure advantageously allows for the transportation optimization of Mail.dat files (discussed hereinafter), allowing the user to specific a pricing scenario for consolidation, co-palletization and commingling services. The present disclosure advantageously provides extremely efficient utility that is capable of achieving an optimized combination of postage and transportation savings for mailers, mail-owners and print brokers.

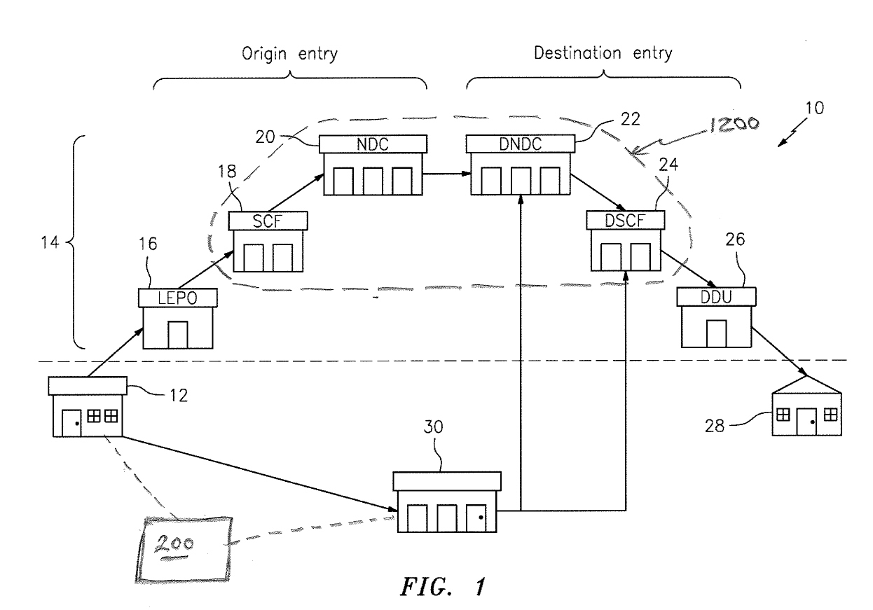

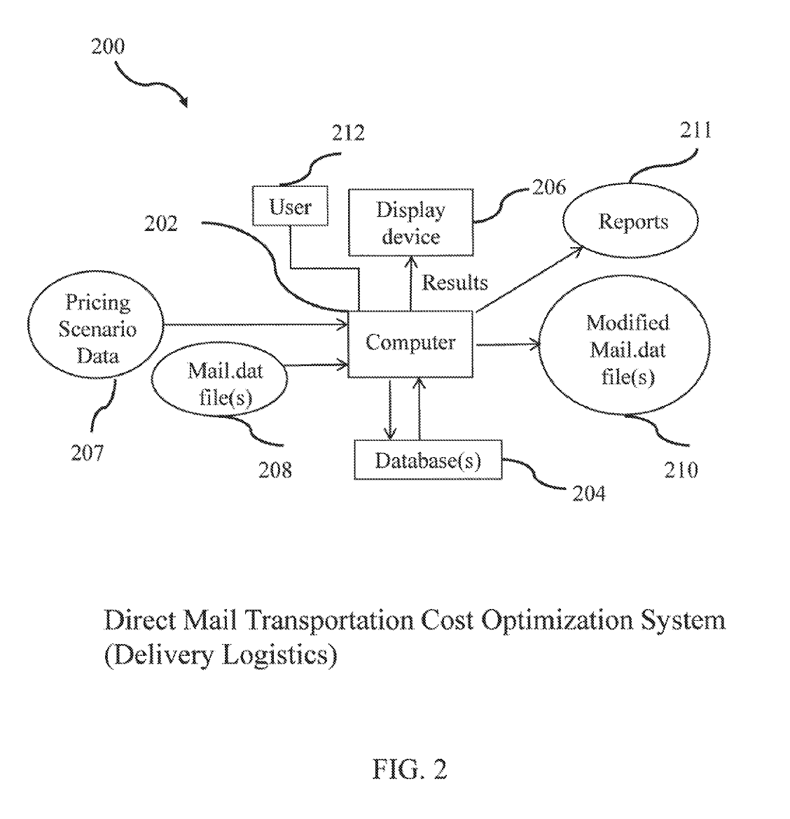

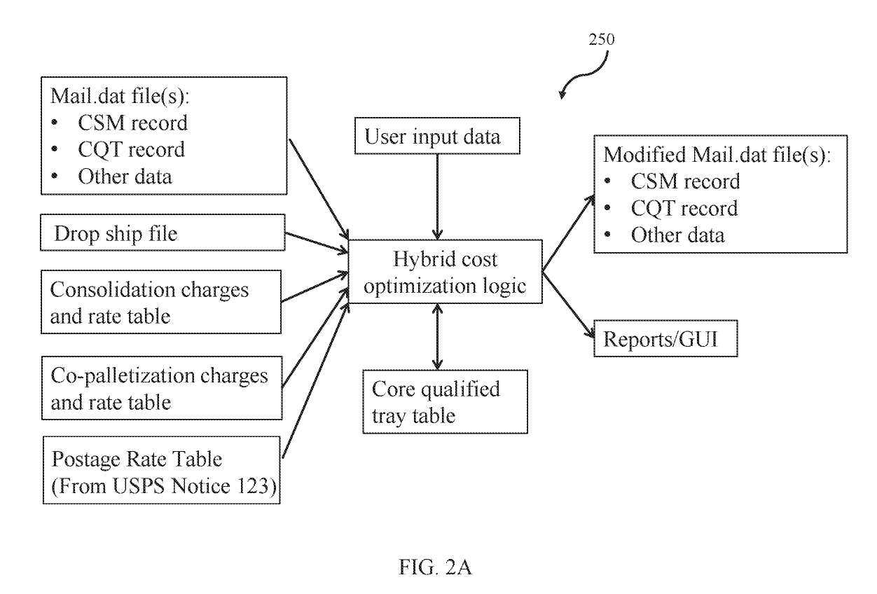

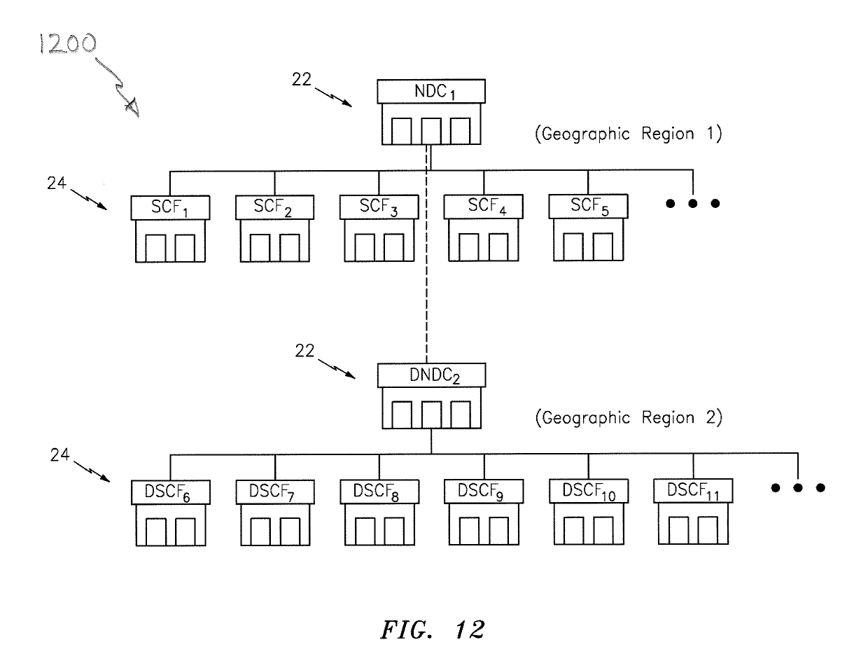

FIG. 1 shows possible mail flow paths for a bulk (or direct) mailer 12 using a known USPS distribution network 14 and how the system 200 (FIG. 2) of the present disclosure may interact with portions of the network 14. The USPS distribution network 14 includes “origin entry” locations: local entry post office (or “LEPO”) 16, origin sectional center facility (“SCF”) 18 and origin network distribution center (“NDC”) 20. The USPS distribution network 14 further includes “destination entry” locations: destination NDC (or “DNDC”) 22, destination SCF (or “DSCF”) 24 and destination delivery unit (“DDU”) 26 or destination post office, the post office which will deliver the mail to its final destination address. The USPS locations are shown in descending order from the mailer 12 to a mail piece's addressed location 28. The USPS distribution network 14 includes a number of locations for each type of the origin entry locations 16, 18, 20 and the destination entry locations 22, 24, 26. Thus, which particular USPS location of each type of USPS location a mail piece will flow to is determined based on which USPS location services that mail piece's addressed location 28. Also, whether a particular USPS location is the origin entry location 16, 18, 20 or the destination entry location 22, 24, 26 depends on where a mail piece is being mailed to and from. Thus, a particular SCF location may be an origin entry location 18 for mail pieces for one mailing, but a destination entry location 24 for a different mailing. There are approximately 21 NDCs and 200 SCFs in the USPS distribution network 14. There are also eight auxiliary service facilities (not shown) that handle both NDC and SCF mail. For present description purposes the NDCs and auxiliary service facilities will be collectively referred to as “NDCs.” Each NDC is associated with a geographic region, and each SCF is associated with a particular NDC. Depending on the area of the country, the number of SCFs assigned to an NDC varies, as shown in by an expanded view of a section 1200 of FIG. 1, as shown in FIG. 12.

A mailer 12 (FIG. 1) has the ability to mail a bulk mailing by depositing the mail pieces at a USPS “local entry” post office 16. Depositing mail pieces with a local entry post office 16, i.e. the USPS location furthest up the USPS distribution network 14, will incur the highest postage rates and, thus, will typically incur the mailer 12 the least possible shipping savings. Alternatively, the mailer 12 may “drop-ship” mail pieces into the USPS distribution network 14 by delivering its mail pieces directly to one or more of the “destination entry” locations 22, 24, 26. Depositing mail pieces with one or more of the destination entry locations 22, 24, 26, i.e., drop-shipping, will incur lesser postage rates than depositing the mail pieces with a local entry post office 16 because there are less steps in the process to the final delivery destination. However, there may be costs associated with delivering the mail pieces to the destination entry locations 22, 24, 26 compared to delivering to the local entry post office 16, such as, for example, shipping charges. Therefore, it is advantageous to drop-ship mail pieces if the sum of the costs associated with delivering the mail pieces to the destination entry locations 22, 24, 26 including destination entry postage rates is less than the sum of the costs of delivering the mail pieces to local entry post office 16 including local entry postage rates, in other words, if “drop-ship savings” exists.

A mail “job” is an undertaking to mail any number of mail pieces within a specified timeframe. For any given job, a mailer 12 may drop-ship mail pieces to one of the destination entry locations 22, 24, 26 directly or, alternatively, a mailer 12 may drop-ship some or all of the mail pieces of a job using a third party vendor 30. A third party vendor 30 may provide known “consolidation,” “co-palletization” (or “co-pal”) and/or “commingling” services on bulk mailing shipments before drop-shipping the mailer's 12 mail pieces to the destination entry locations 22, 24, 26, as discussed in greater detail below.

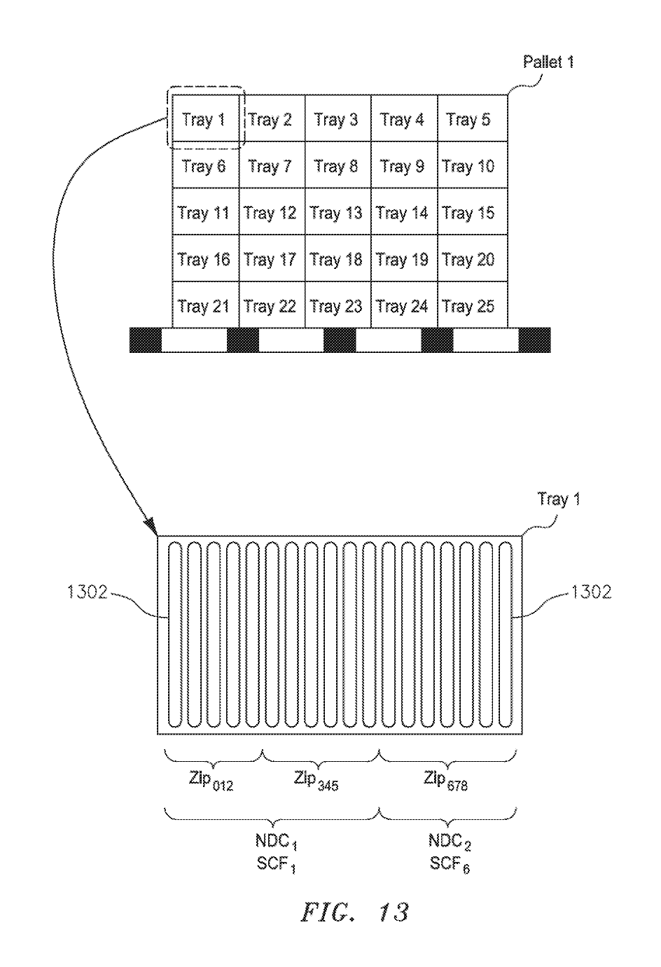

The USPS enforces restrictions for depositing bulk mail shipments at the destination entry locations 22, 24, 26. The USPS requires that mail pieces deposited at destination entry locations 22, 24, 26 be placed in trays and also that the collection of trays be contained on a pallet, e.g., there are typically 200-250 mail pieces on a tray and 40 trays on a full pallet (however, more or less mail pieces and trays may placed on a tray or pallet). Further, each pallet will only be accepted at the particular destination entry location 22, 24, 26 if each mail piece contained on the pallet is “qualified” for that particular destination entry location 22, 24, 26. A mail piece is “qualified” for the particular destination entry location 22, 24, 26 if its addressed location 28 (destination address, e.g. a home or business address) is located within that destination entry location's 22, 24, 26 service area. For example, a mail piece with a destination address location 28 located in Springfield, Mass. would not be qualified to be accepted at NDC Denver, Colo. because that NDC does not provide service to that address. However, that mail piece would be qualified to be accepted at NDC Springfield, Mass. Accordingly, if a pallet contains, for example, 1,000 mail pieces, and if only one of those mail pieces contained the addressed location 28 located in Springfield, Mass., then the entire pallet is not “qualified” to be accepted at NDC Denver, Colo. and, thus, cannot be drop shipped there. However, if the remaining pieces all have addressed locations 28 within the service area of NDC Denver, Colo. and the disqualifying mail piece addressed to Springfield, Mass. were removed from the pallet, then the pallet would be qualified to be deposited at NDC Denver, Colo. The disqualifying mail piece can be removed either individually from its tray, i.e., individual mail piece removal, or by removing the entire tray containing the disqualifying mail piece from the pallet, i.e., tray removal. A more detailed example of qualification is shown in FIG. 13 and is discussed below.

The USPS further requires that pallets of mail pieces being deposited at destination entry locations 22, 24, 26 are associated with one or more electronically deposited specification files. For example, the specification files may be “Mail.dat®” files or “Mail.XML” files. The Mail.dat file is an industry standard file format, maintained and owned by International Digital Enterprise Alliance, Inc. (“IDEAlliance”), that contains detailed information about a presorted mailing job. For the purposes of the present disclosure, the apparatuses and methods described herein are shown and described with use of Mail.dat files. However, it should be readily understood that the systems and methods disclosed herein may be configured to utilize other specification file types, such as Mail.XML files. Generally, Mail.dat files are generated by the mailers 12 with “pre-sort” software that processes one or more mail lists for a mail job. Mail.dat files generated with pre-sort software will be initially mark each of the mail pieces contained in the file to enter either a local entry post office 16 or one of the USPS destination entry locations 22, 24, 26, which may be referred to as the “as-marked” entry location. The Mail.dat files are typically “zip” files that each contain at least eight text files, which includes information about each of the mail pieces within a mail job. Each Mail.dat file includes, among other things, a container summary (“CSM”) record and a container quantity (“CQT”) record. The CSM record includes identification of the as-marked USPS entry location, a container grouping identification field, a postage grouping identification field, label destination lines 1 and 2, label contents lines 1 and 2, and user info line 2, scheduled induction date, scheduled pickup date, entry zip code/type/locale key. The container grouping identification field is available for marking by the mailers 12, the third party vendors 30 for various sorting and identification purposes. The CQT record includes the drop ship discount level for each mail piece, for example, the NDC or SCF postage rate.

As discussed above, prior to drop-shipping the mailing job at the destination entry locations 22, 24, 26, the mailer 12 and/or a third party vendor 30 may perform “consolidation,” “co-palletization” and/or “commingling” services on the mail pieces. These services may be performed in order to achieve postage savings and/or to manipulate pallets in order to qualify the pallets for certain of the destination entry locations 22, 24, 26. “Consolidation” includes grouping pallets together that qualify for the same destination entry location 22, 24, 26 and placing those pallets on the same transportation method for delivery at the destination entry location 22, 24, 26, such as delivery by truck, plane, boat, train or the like. Given that each transportation method has its own cost for transporting and delivering bulk mailings to a destination entry location 22, 24, 26, consolidation may improve shipping and overall cost efficiency by maximizing the amount of cargo contained within each trip of the transportation method and, thus, spreading the cost of the transportation method across a larger number of mail pieces and mailers. “Co-palletization” encompasses consolidation, but further includes rearranging trays within pallets, adding trays to pallets and/or removing trays from pallets. Thus, co-palletization improves shipping and overall cost efficiency by manipulating pallet compositions to qualify for drop-ship delivery deeper within the USPS distribution network 14. “Commingling” includes removing and rearranging individual mail pieces (e.g. letters) from trays on pallets to form newly arranged trays and pallets. Commingling may also improve shipping and cost efficiency by manipulating pallet and tray compositions to qualify for delivery deeper within the USPS distribution network 14.

Methods of bulk mailing logistics according to embodiments of the present disclosure specifically identify, contemporaneously with mailing jobs, which mail pieces (or trays or pallets) in the mail jobs are to receive either consolidation services, co-palletization services or commingling services. Thus, methods according to embodiments of the present disclosure are configured to achieve greater cost savings than previously known mailing techniques.

Referring to FIG. 2, an exemplary direct mail hybrid cost optimization system 200 is shown according to embodiments of the present disclosure. The system 200 includes a computer 202, database 204 and display device 206. The computer 202 is configured to store and retrieve information from the database 204 (and may include other system memory or computer readable storage medium or server) as well as output information for display on the display device 206. The computer 202 is also configured to receive pricing scenario data 207 and at least one Mail.dat file 208 as input and also output modified Mail.dat file(s) 210 and/or reports 211.

Referring to FIG. 2A, an exemplary direct mail hybrid cost optimization data flow diagram 250 is shown. The diagram shows, generally, inputs and outputs that may be associated with a direct mail hybrid cost optimization system 200 (FIG. 2). As is discussed in greater detail below, inputs may include Mail.dat file(s), drop ship file, consolidation charges and rate table, co-palletization charges and rate table, USPS Notice 123, and user input data. Methods and systems of the present disclosure may include hybrid cost optimization logic, which utilizes the above-mentioned inputs to determine the optimized shipping method, which may be performed by the computer 200 (FIG. 1). The logic may utilize the above-mentioned inputs to create a core qualified tray table (as discussed herein), which may be stored in memory (or database 204) of the computer 200 or on a separate server. When an optimized shipping method is determined, the hybrid cost optimization logic may generate output(s) of report data, graphical user interface (GUI) data, and modified Mail.dat file(s), indicative of the optimized shipping method.

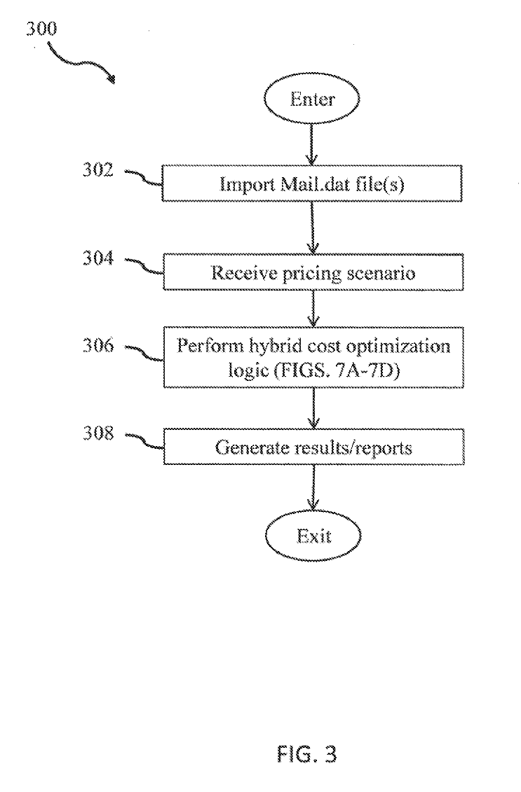

Referring to FIG. 3, an exemplary direct mail hybrid cost optimization method 300 capable of being performed by the system 200 of FIG. 2 is shown. The exemplary method 300 generally includes the step of first importing one or more Mail.dat files 302 into the system 200. The imported Mail.dat files may be stored within database 204. Then, the method 300 includes receiving the pricing scenario 304, which involves, among other things, defining the variable parameters that are associated mailing costs including, for example, postage rates, service rates, and other factors. Then, the method 300 includes performing hybrid cost optimization 306, which includes using the values obtained during the receiving the pricing scenario step 304 to iteratively calculate potential shipping methods until an optimized shipping method is determined. Then, the method 300 includes generating results and reports 308, which includes outputting determined results to the display device 206 (FIG. 2) so that the results of the method 300 are visible to a user. The results may be output to a graphical user interface 400, as is discussed below. The method 300 is discussed in greater detail below.

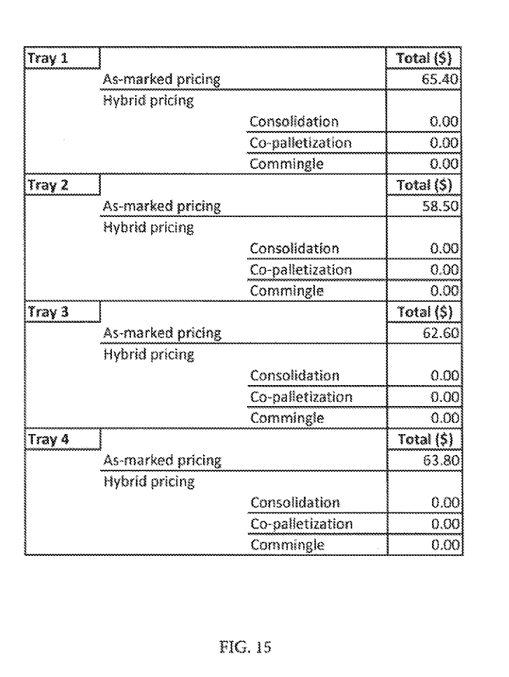

The process 300 begins at step 302 with the importing of one or more Mail.dat files 208 (FIG. 2) into the system 200 (FIG. 2), which includes a user selecting a folder location containing the one or more Mail.dat files 208 to be imported. The Mail.dat files 208 are parsed and saved into databases (e.g. SQL database or the like) for access. Once parsed and saved, using a local object model, such as “FileHelpers” library, the Mail.dat files 208 are able to be queried directly and transformed into data objects. The text data included in the Mail.dat files are converted into relational programming objects and stored in database(s) 204, for example, the text data contained in the CSM and CQT records. The computer 202 generates tray objects in memory or database(s) 204 for each tray contained in the Mail.dat files 208. The pricing information for the trays as-marked in the Mail.dat files 208 is stored as a static value for each tray object. A variable hybrid field is generated that is configured to receive and store hybrid pricing calculated during the process 300, which may be changed during each iteration of the process 300. The variable hybrid pricing field may include consolidation pricing (if applicable), co-palletization pricing (if applicable) and/or commingle pricing (if applicable). An illustration of such tray objects is shown in FIG. 15, which shows four tray objects with as-marked pricing stored in memory and the consolidation, co-palletization and commingle pricing stored as $0.00 until changed by the process 300.

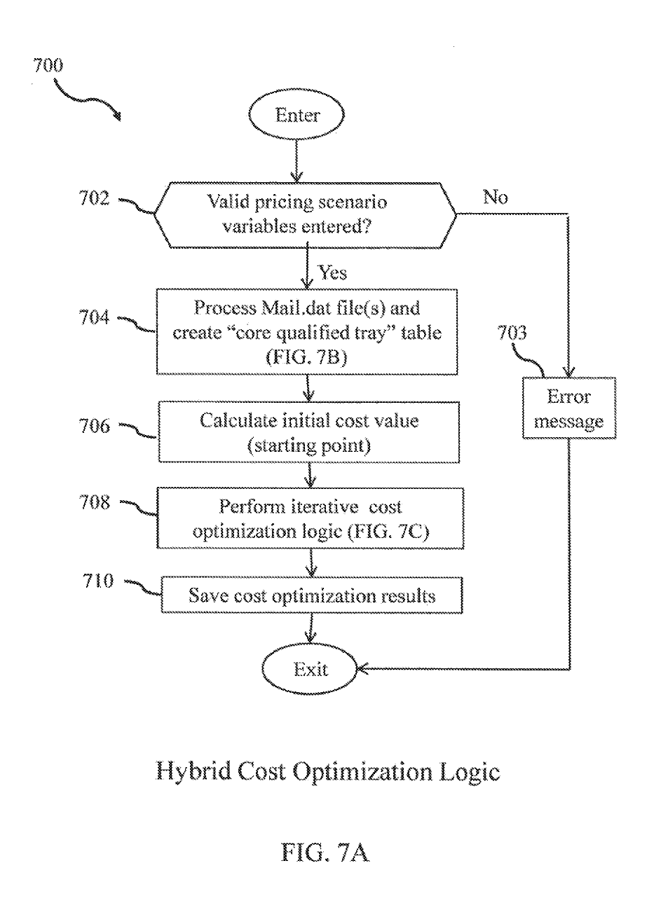

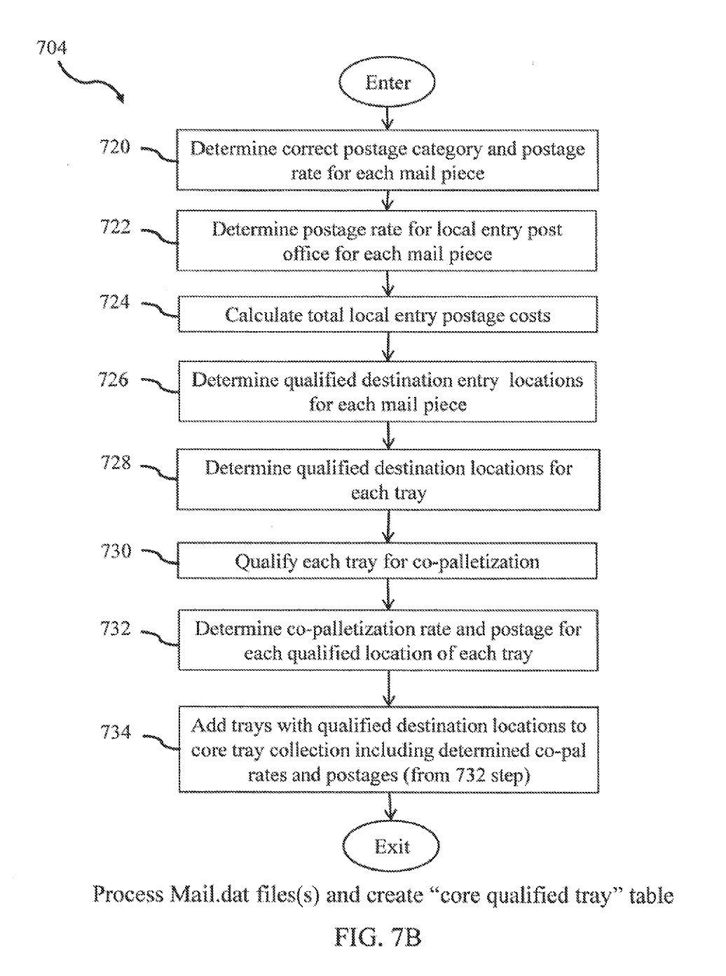

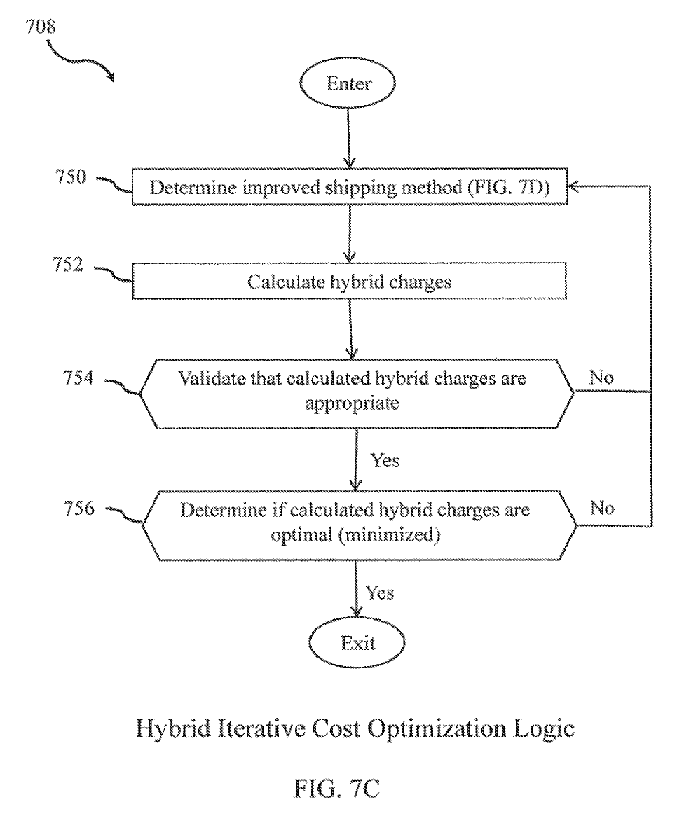

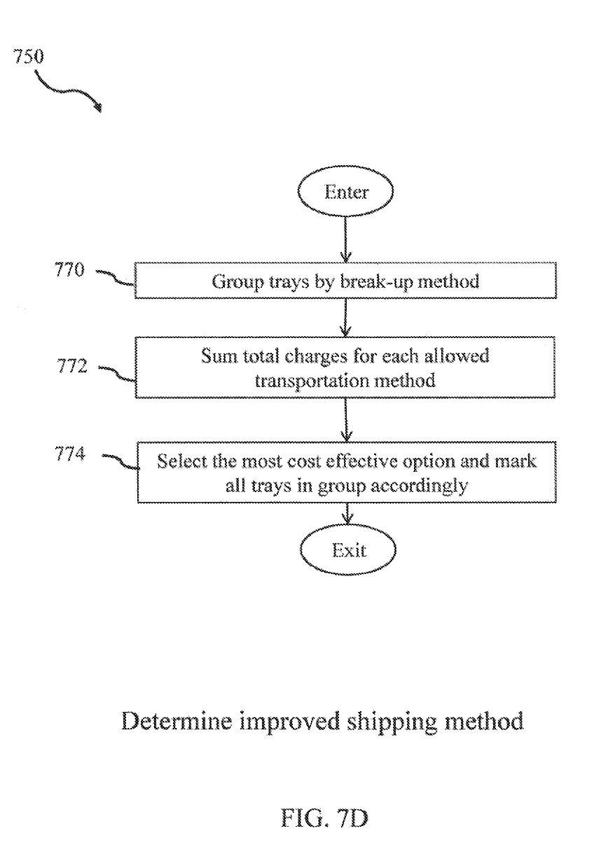

Next, a step 304 receives the pricing scenario, which includes storing of one or more of the following variables (or input parameters or data) into the database 204 or other computer memory: inbound shuttle rate, maximum weight per shuttle, fuel surcharge rate, consolidation charges and rate sheet, consolidation preparation fee, co-palletization charges and rate sheet, minimum destination charge (MDC) aggregation method, commingle rate, postage effective date, transportation break-up method and which bulk/direct mail services are permitted (or selected) by the mailer 12 (FIG. 1) such as consolidation, co-palletization and/or commingle. Next, a step 306 performs a hybrid cost optimization analysis using the Mail.dat file(s) 208 (FIG. 2) and pricing scenario as discussed with FIGS. 7A-7D. The result of step 306 is an improved shipping method and associated cost value that is saved. The saved results may include the computer 202 generating a file to be stored in the database 204 or other computer memory or computer-readable storage medium. Then, a step 308 generates results and reports based on the saved results, after which, the process 300 exits.

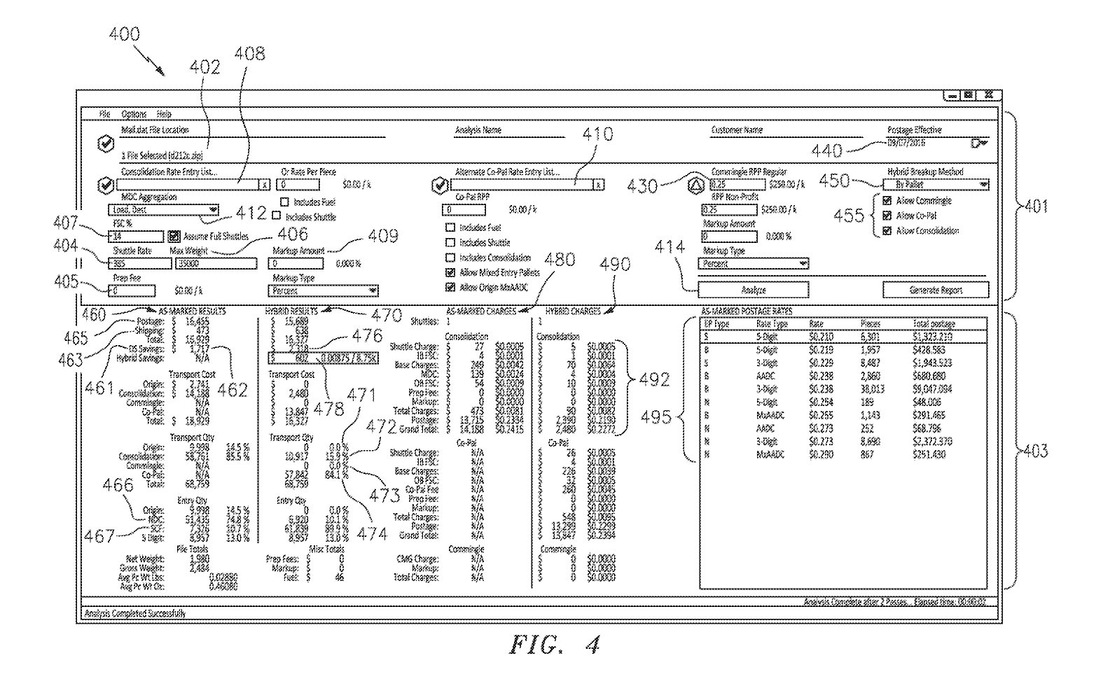

FIG. 4 shows an exemplary graphical user interface 400 provided by the system 200 on the display 206 that the user 212 may interact with in order to supply the above-mentioned input parameters. The graphical user interface 400 has an input section 401 and an output (or results) section 403.

Referring to FIG. 4, the Mail.dat file 208 is input by the user in a field 402 in the graphical user interface (or “GUI”) 400. The inbound shuttle rate 404 is the charge per trip to have one inbound shuttle bring a load of a mail job from the mailer 12 to the third party vendor 30 (FIG. 1) to perform bulk mailing services on the mail pieces. This inbound shuttle rate 404 can be input by the mailer 12. Alternatively, the inbound shuttle rate 404 may be input by the third party vendor 30 or pre-stored in computer memory of the system 200 (FIG. 2) if, for example, the third party vendor 30 provides inbound shuttle services for mailers 12. The inbound shuttle rate 404 may be, for example, $500.00 per shuttle trip. Other rates may be used, if desired.

The maximum weight per shuttle 406 is a variable that defines how many mail pieces, in terms of weight, may be transported via an inbound shuttle, for example, 20,000 lbs. The mailer 12 (FIG. 1) or the vendor 30 may enter a maximum weight that is less than what the inbound shuttle can actually transport in order to decrease the likelihood of mail pieces being damaged by loading an inbound shuttle too compactly. Thus, by entering a maximum weight less than what the inbound shuttles can actually transport, the system 200 will determine the mail pieces to be shuttled for bulk mailing services across an appropriate number of inbound shuttles. Thus, if 25,000 lbs of mail pieces are to be shuttled for bulk mailing services and the maximum weight entered into computer memory is 20,000 lb, then at least two shuttles will be required or accounted for. The actual physical loading of the shuttles may vary from the loading determined by the system 200.

The fuel surcharge rate 407 is a variable that accounts for fluctuating fuel prices as a cost that contributes to the total cost of transporting the mail pieces for bulk mail services via inbound and outbound shuttles to and from the third party vendor 30. The fuel surcharge can be stored as a flat fee or, alternatively, as a percentage of the inbound shuttle rate.

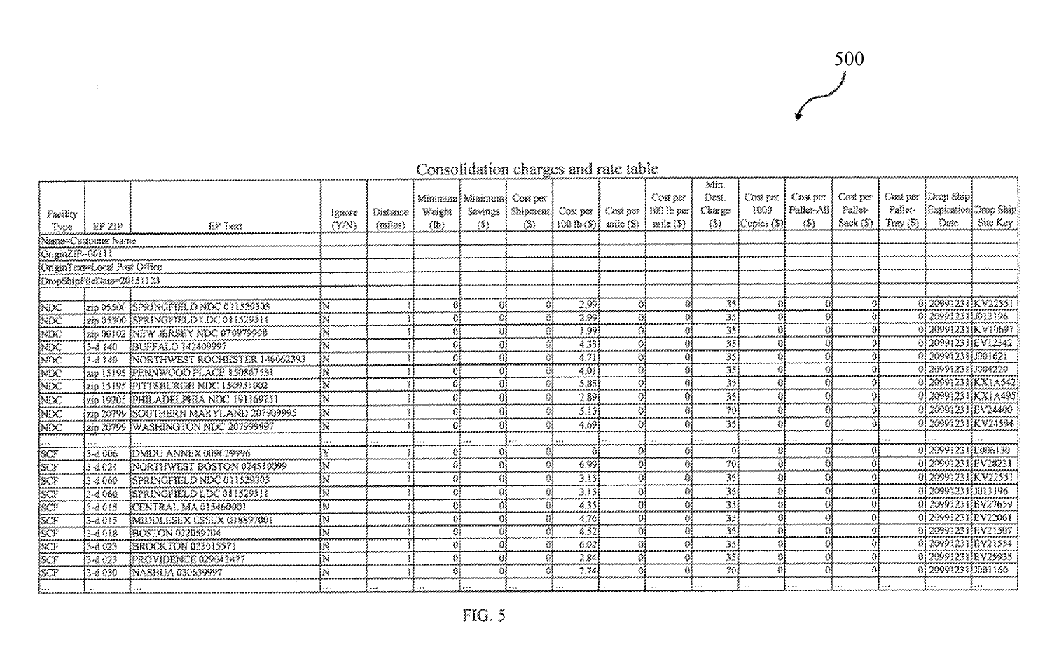

The consolidation charges and rate may be entered in the field 408 in the graphical user interface 400 which provides the applicable rates for performing consolidation services on mail pieces. Referring to FIG. 5, a consolidation charges and rates table 500 provides the applicable rate for consolidation may be listed in columns as cost per shipment, cost per weight, cost per mile, cost per weight per mile or cost per number of mail pieces. For example, the consolidation rate may be listed as $7.00/100 lb or $20.00/1,000 mail pieces. The listing of applicable rates will include a consolidation rate for each USPS entry location. For brevity purposes, only some of the NDC and SCF USPS locations are shown for illustration. Optionally, the consolidation charges and rate table 500 may include an “ignore” column that indicates if a USPS entry location is to be ignored (e.g. if that location is out of service or otherwise not usable). If a USPS entry location is ignored, the system 200 will not take into account that USPS entry location when determining which bulk mailing services to perform on mail pieces.

There may also be a column for MDCs. In particular, when utilizing consolidation services, if the amount charged for delivering a given amount of mail pieces to an entry location would not amount to a minimum threshold at the applicable rate, then the vendor 30 (FIG. 1) may have an MDC applied in lieu of the amount that would be charged at the applicable rate. An MDC may be, for example, $35.00. Thus, if 200 lb of mail pieces were ordered to receive consolidation services for delivery to a USPS location and having a consolidation rate of $7.00/100 lb, then the consolidation charges would be $35.00 and not $14.00 for that order. The consolidation rates and MDCs may vary or be the same for each USPS entry location. For example, in the table 500 of FIG. 5, the MDC is $35.00 for NDC zip 19205 and $70.00 for NDC zip 20799. The consolidation charges and rate sheet may be in any computer readable table structured format, for example, a comma separated values (“CSV”) file. Instead of entering a consolidation charges rate sheet, a consolidation rate per piece may be entered, which is a flat fee per piece no matter the destination entry location 22, 24, 26 of the mail pieces. The consolidation charges and rate sheet can be inputted and stored into computer memory either by the mailer 12 or the third party vendor 30.

The consolidation preparation fee is for performing consolidation services. This fee may be listed per mail piece, for example, $0.003/piece. This preparation fee reflects the mailer's 12 costs for preparing the physical mailing for consolidation services. This optional variable input may reflect, for example, labor and floor space cost for building pallets for the mail job. This variable may be input by the mailer 12 or the third party vendor 30.

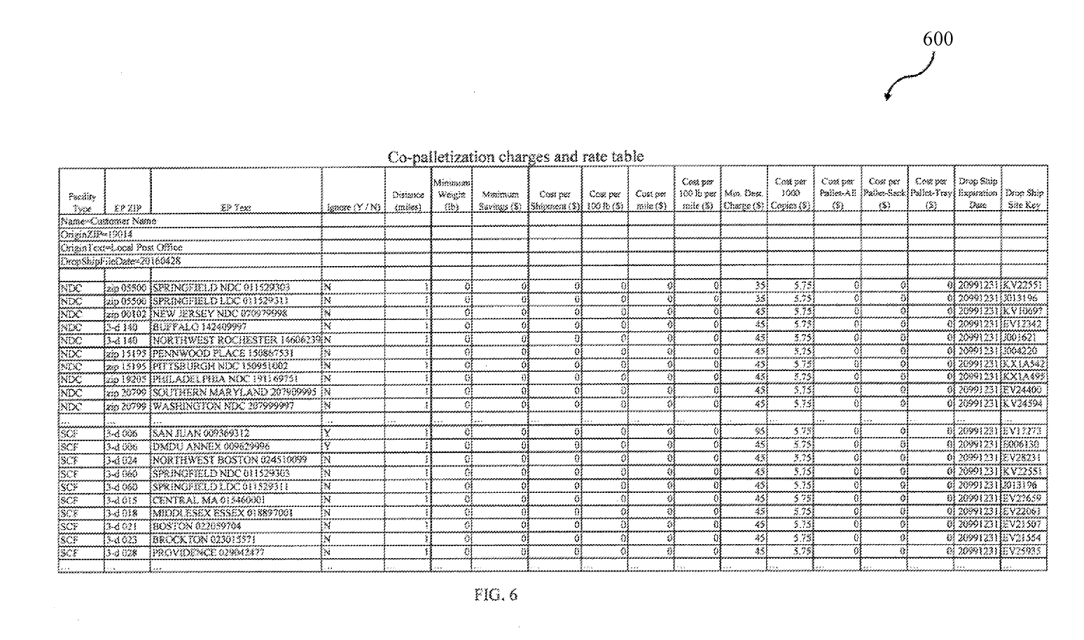

Referring to FIG. 4, co-palletization charges and rates may be entered in the field 410 in the graphical user interface 400, which provides the applicable rates for performing co-palletization on mail pieces. Referring to FIG. 6, table 600 shows, similar to consolidation, the applicable rate for co-palletization charges, which may be listed in columns as cost per shipment, cost per weight, cost per mile, cost per weight per mile or cost per number of mail pieces. For example, the co-palletization rate may be listed as $9.00/100 lb or $23.00/1,000 mail pieces. The listing table 600 of applicable rates will include a rate for each USPS entry location. For brevity purposes, only some of the NDC and SCF USPS locations are shown for illustration. Optionally, the co-palletization charges rate may include a field that indicates if a USPS entry location is to be ignored. If a USPS entry location is ignored, methods according to the present disclosure will not take into account that USPS entry location when determining which bulk mailing services to perform on mail pieces. Similar to consolidation services, when utilizing co-palletization services, the vendor 30 (FIG. 1) may have an MDC applied if the amount charged for delivering a given amount of mail pieces would not amount to a minimum threshold at the applicable rate, for an entry location if the minimum destination aggregation method is selected, as will be discussed below.

An MDC could be, for example, $45.00. Thus, if 200 lb of mail pieces were ordered to receive co-palletization services for delivery to a USPS location and having a co-palletization rate of $9.00/100 lb, then the consolidation charges would be $45.00 and not $18.00 for that given order. The co-palletization rates and MDCs may vary or be the same for each USPS location. The co-palletization charges and rate sheet may be in any computer readable table structured format, for example, a CSV file. Instead of entering the co-palletization charges and rate table 600 (or database), a co-palletization rate per piece may be entered, which is a flat fee per piece independent of the destination entry location 22, 24, 26 (FIG. 1) of the mail pieces. The co-palletization charges and rate table 600 can be inputted and stored into computer memory either by the mailer 12 or the third party vendor 30.

The minimum destination charge (MDC) aggregation method is an option that allows for the consideration of which aggregation method will be utilized by the system/logic for determining how to determine and allocate MDCs. Different MDC aggregation methods include: (1) shuttle/job/destination; (2) shuttle/destination; (3) destination; and (4) pallet. For destination aggregation method, the MDC is determined based on whether the amount charged for servicing mail pieces satisfies a minimum threshold for each allowable USPS entry location. Under MDC aggregation method (1), the mailer 12 is most likely to incur a minimum charge adjustment because they have the most granular grouping of pallets used to perform the assessment. Only pallets on the same shuttle, with the same job, and the same destination are aggregated together. Under MDC aggregation method (2), the mailer 12 is less likely than MDC aggregation method (1) to incur a minimum charge because pallets on the same shuttle, going to the same destination are aggregated together regardless of whether or not they are part of the same mail job. Under MDC aggregation method (3) the client is least likely to incur a minimum charge because the only consideration when performing the aggregation is the destination, regardless of inbound shuttle and mail job.

Referring to FIG. 4, the commingle rate shown in field 430 in the graphical user interface 400 is the applicable rate for performing commingling services on mail pieces. Given that many third party vendors 30 charge a flat rate for commingle services without regard to a particular USPS destination entry location 22, 24, 26 (FIG. 1) the mail pieces intended for, the commingle rate may be entered as a flat rate per piece. For example, $25.00/100 lb or $0.25/piece (i.e. $250.00/thousand pieces as shown in FIG. 4).

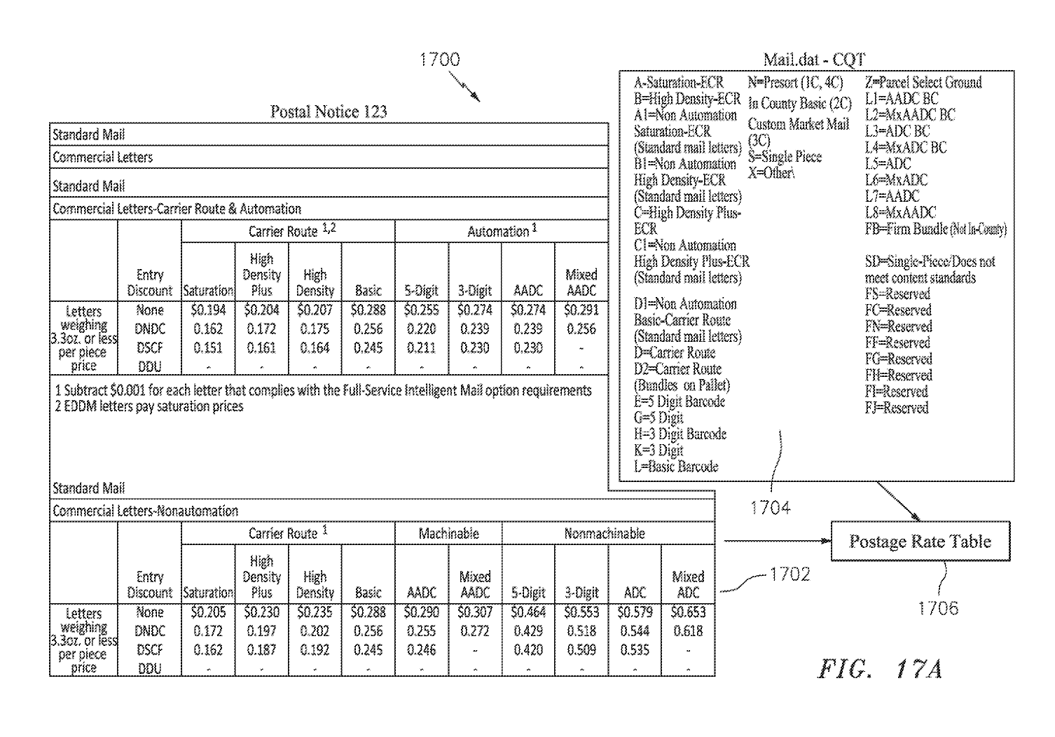

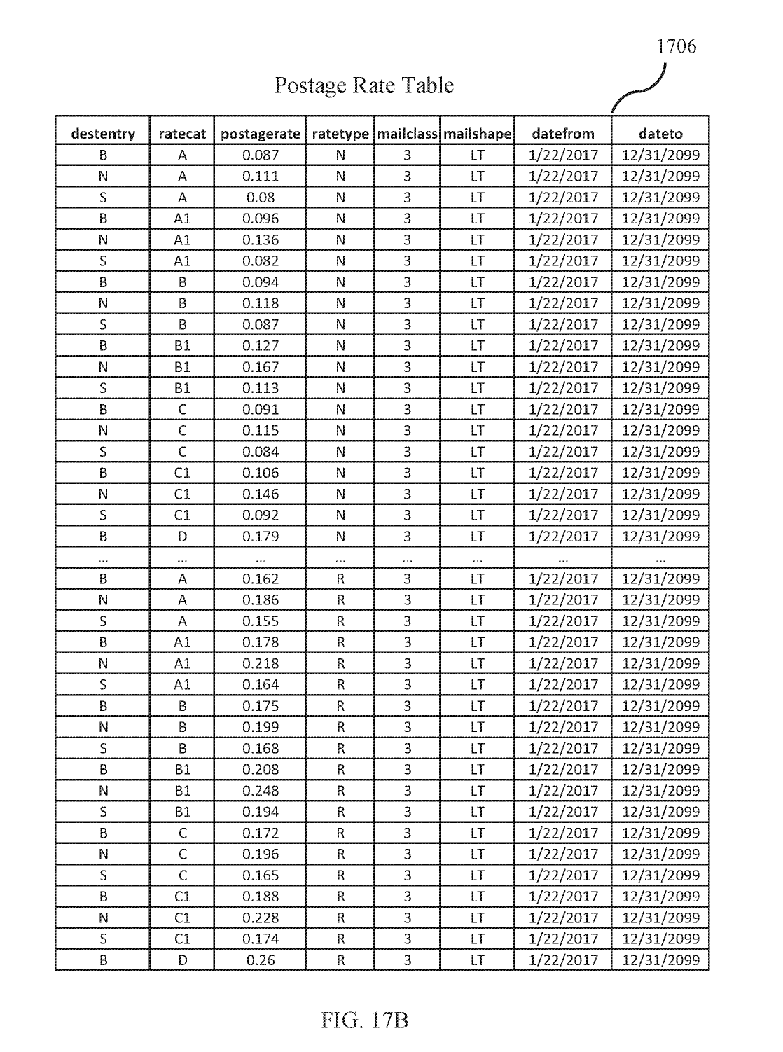

A postage effective date field 440 includes the amount of appropriate postage for mail pieces based on type/level of USPS entry location for the time period of the mail jobs. The appropriate postage will reflect the USPS required postage for mail pieces entering NDCs 22, SCFs 24 and DDUs 26 for trays and pallets containing mail pieces with addressed locations 28 within 5-digit zip code, 3-digit zip code, automated area distribution centers (“AADC”), and mixed AADCs. Currently, the USPS does not offer discounted postage rates for drop-shipping mail pieces at DDUs 26. It would be understood by those of skill in the art that USPS Postal Notice 123 does not include an entry discount for “DDU.” However, it should be readily understood that if the USPS were to allow entry discounts for DDUs 26, then embodiments according to the present disclosure may include consideration of DDUs 26. The system 200 may be configured to store in the database 204 or retrieve via the computer 202 information from USPS Postal Notice 123. As depicted in the diagram 1700 of FIG. 17A, based on a USPS Postal Notice 123 1702 and Postage Rate Categories 1704 set forth in the CQT record of a Mail.dat file, a postage rate table 1706 may be generated. For example, as shown in FIG. 17B, which details a partial view of a sample generated postage rate table 1706, the postage rate table 1706 contains the current postage rate information for all mail piece types and entry locations. The postage rates table 1706 shown in FIG. 17B includes destination entry (“destentry”) codes: B=DNDC; S=DSCF; and N=None. The rate category (“ratecat”) column corresponds to codes described in the Mail.dat file CQT record Mail Category 1704 and correspond with USPS Postal Notice 123 1702 presort level. The rate type (“ratetype”) column has codes for non-profit and regular mailings: N=nonprofit; and R=regular. Mail class may, for example, always be Class 3 and mail shape may, for example, always be letters (“LT”).

The transportation hybrid break-up method variable/field 450 allows the mailer 12 to select a particular break-up method from a group of allowable methods. The group of allowable transportation break-up methods includes: (1) by tray; (2) by pallet; (3) by destination; and (4) by job. A mailer 12 can enter this selection via a drop down menu, toggle field or the like. The selected transportation break-up method will determine the granularity of the bulk mailing optimization, as will be discussed in greater detail below.

The type of bulk mail services shown as check boxes 455 allowed (or selected) by the mailer 12 can be configured to be stored via a toggle field entry format. Thus, only bulk mail services toggled to the affirmative will be accounted for by methods according to the present disclosure.

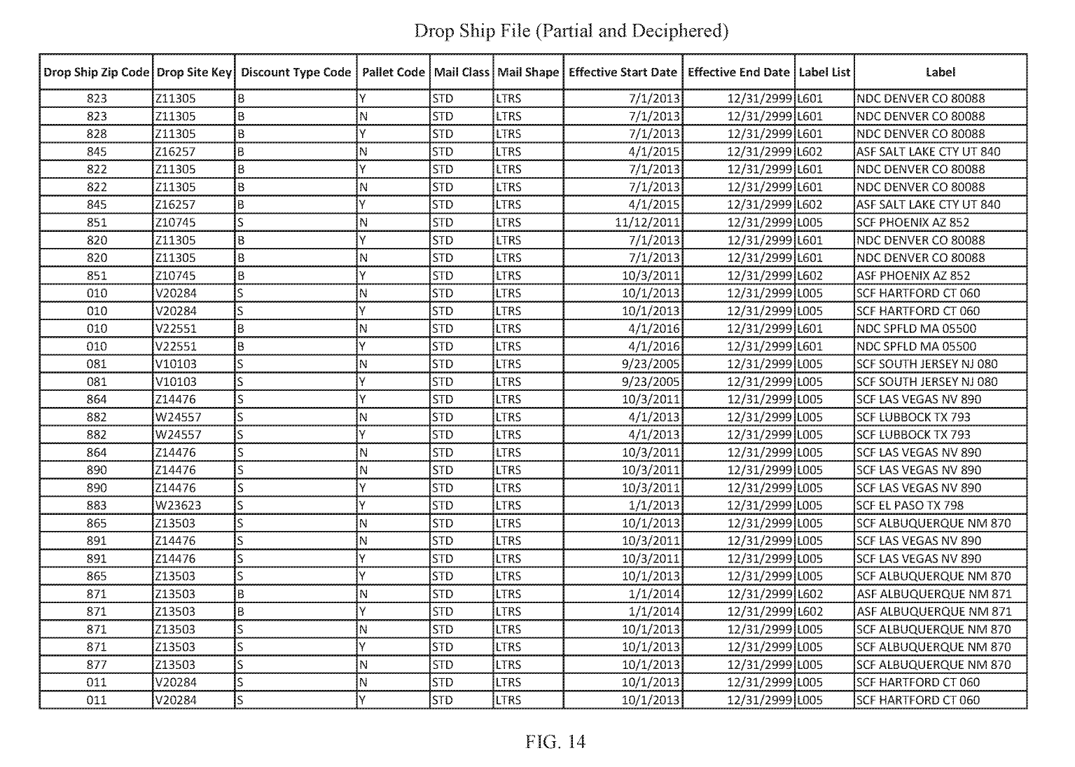

While not shown in the graphical user interface shown in FIG. 4, a drop-ship and labeling list file partial view as shown in FIG. 14, may be stored in the system 200. These files are utilized for co-palletization qualification as is discussed below. Labeling list data provided by the USPS assists mailers 12 and vendors 30 with presorting mail. It provides the active, originating 3-digit and 5-digit zip code data along with their destination entry locations for labeling purposes. The drop-ship and labeling list file is a listing of zip codes, mail classes and labeling lists that are permitted to be deposited with the USPS entry locations. The drop-ship and labeling list file may be configured based on information made available by the USPS, for example, based on information made available through USPS's Facility Access and Shipment Tracking (“FAST”) initiative.

Referring to FIG. 7A, the step 306 (FIG. 3) of performing the hybrid cost optimization begins at step 702, which determines whether the pricing scenario received in step 304 (FIG. 3) is valid. In particular, the step 702 ensures that the system 200 is properly primed to perform analysis. Validating the pricing scenario may include checking input fields to confirm that false numbers have not been entered into input fields through human error or other mistake. False numbers include, but are not limited to, non-entered input fields, non-numerical character entries, numerical entries with more than one decimal point entered, negative numbers, or the like. If the result of step 702 is No, there is an invalid entry and a step 703 displays an error message to the user and the process exits. If the result of step 702 is Yes, each required input field of the pricing scenario is valid and step 704 processes the Mail.dat file(s) 208 and creates a core qualified tray table/database as described in FIG. 7B, discussed hereinafter.

Next, a step 706 calculates the initial starting point for performing an iterative analysis, which includes calculating the consolidation charges for all of the freight listed in the Mail.dat file(s), as follows. First, all of the non-local entry freight is allocated to shuttles by destination and then by pallet ID. The allocation to shuttles will be based on the weight of the freight in accordance with the maximum weight per shuttle variable entered, as discussed above. Then, the entered shuttle charges as are applied. The step 706 then applies the consolidation charges based on consolidation charges and rate table 500, as discussed above, in view of the information imported from the Mail.dat file(s). Also, if any consolidation preparation fees or agent markups are entered, those may be applied as well. Once all the above fees are applied, the step 706 generates an initial cost that is based on all of the freight being marked for consolidation services for delivery to USPS entry locations as-marked in the Mail.dat file(s). This initial cost is stored by step 706 as an initial cost value. Once the initial cost value has been stored, a step 708 performs an iterative analysis to determine the transportation methods breakdown that provides optimal cost, as described in FIG. 7C. After the optimal cost transportation method has been determined a step 710 saves the results in memory and the process exits.

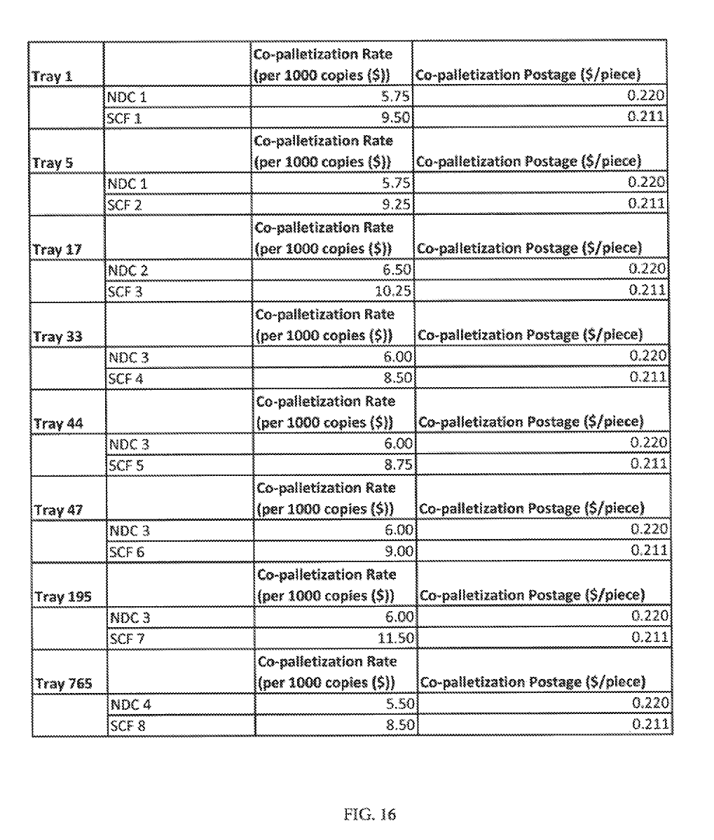

Referring to FIG. 7B, the step 704 of processing of the Mail.dat file(s) 208 (FIG. 2) includes a step 720 which determines the correct postage category and postage rate for each mail piece in each tray imported from the Mail.dat file(s). Then, a step 722 determines the postage rate for entry into the local entry post office 16 (FIG. 1). Next, a step 724 calculates the total local entry postage costs by summing the local entry postage rates for each mail piece from step 722. Then, a step 726 determines the qualified destination entry locations 22, 24, 26 (FIG. 1) for each mail piece, in other words, the NDCs 22, SCFs 24 and, if applicable, DDUs 26 each mail piece is qualified to be deposited with. Then, a step 728 determines the qualified destination locations 22, 24, 26 for each tray, i.e. NDCs 22, SCFs 24 and DDUs 26 each tray is qualified to be deposited with, if any. Step 728 determines the qualified destination location of a tray, for both 3-digit and 5-digit trays, by cross referencing the 3-digit tray zip code of each mail piece within the tray with the zip codes listed in the drop-ship and labeling list file, partial version being shown in FIG. 14, where the mail class is standard mail class, mail shape is letters, and discount code is NDC or SCF in order to determine where the tray is eligible to enter. As discussed above, if the consolidation charges and rate table 500 or the co-palletization charges and rate table 600 input fields includes an “ignore” instruction for any particular USPS entry locations, the computer 202 will not determine any of the mail pieces to be qualified for those USPS locations even if the mail pieces would be qualified to be deposited at one or more of those locations by USPS standards. Ignore instructions may be included because, for example, the vendor 30 does not provide transportation/shipping services to the “ignored” locations or a given location is not available for some reason (e.g. closed for renovating or the like). Next, a step 730 qualifies each tray for co-palletization services, which includes determining whether each tray has any NDCs 22, SCFs 24 and/or, if applicable, DDUs 26 that the tray is qualified to be deposited with. Then, a step 732 determines the co-palletization rate and postage for each qualified location for that tray, if any. Next, a step 734 adds each tray that has at least one qualified destination location 22, 24, 26 to a “core tray” (or “qualified tray”) collection stored in memory as an object collection (i.e. a table or database) including each tray's co-palletization rate and postage (for each qualified USPS entry location) determined in step 732. FIG. 16 shows an illustration depicting a portion of such a core qualified tray collection (or table). After performance of step 734, the process exits.

Referring to FIG. 7C, the step 708 (FIG. 7A) performs iterative analysis beginning at a step 750 that determines an improved shipping method discussed more herein with FIG. 7D. Then, a step 752 calculates the hybrid charges (or costs associated with each selected transportation/shipping method). Then, a step 754 validates that the calculated 752 hybrid charges are appropriate, e.g., not too high or not too low, all trays must have cost and postage, any tray marked for commingle must have a commingle fee, any tray on a shuttle must have a shuttle fee, and the like. Next, a step 756 determines if the calculated 752 hybrid charges are optimal.

After the improved (or more optimal) shipping method has been determined in the step 750, a step 752 calculates the hybrid charges (or costs). Similar to determining the initial cost value starting point with step 706, as discussed above, first, all of the non-local entry freight is allocated to shuttles by destination and then by pallet ID. The allocation to shuttles will be based on the weight of the freight in accordance with the maximum weight per shuttle variable entered, as discussed above. Then, the shuttle charges as entered are applied. The step 752 then applies the consolidation charges based on consolidation charges and rate table 500, as discussed above, in view of the information imported from the Mail.dat file(s) 208. The step 752 applies the co-palletization charges based on the co-palletization charges and rate table 600, as discussed above, in view of the information imported from the Mail.dat file(s) 208. The step 752 also applies the commingle rate charges based on the number of mail pieces, or by weight of mail pieces if configured for that rate, marked as being for commingle. Also, if any consolidation, co-palletization or commingle preparation fees or agent markups are entered, those are applied as well. Once all the above fees are applied, the step 752 generates a cost value that is the sum of the consolidation, co-palletization and commingle charges. This cost value will be stored by the step 752 as a cost value.

After the hybrid charges have been calculated 752, a step 754 validates the calculated hybrid charges to determine if the number calculated in step 752 is appropriate. If the result is No, the calculated charges are not appropriate and the step 750 is repeated for another shipping method. If the result is Yes, a step 754 determines if the calculated 752 hybrid charges are optimal by comparing cost values from consecutive runs through the logic 708 to determine if an iterative loop break condition is satisfied. Iterative loop break conditions may include, for example, (1) if consecutively stored cost values are the same and/or (2) if a stored cost value is the same number at least once previously (not necessarily consecutively) and is the lowest cost value of all of the stored cost values. In a first pass through performing the iterative analysis 708 there will only be two values to compare, the initial iterative cost value and the first cost value. However, with each pass through the iterative loop there will be a growing number of stored cost values until one of the break loop conditions are satisfied. If the step 756 determines that an iterative loop break condition has not been satisfied, the step 750 is performed again to determine another improved shipping method. If the step 756 determines that an iterative loop break condition is satisfied, then the process will exit iterative analysis step 708 and proceed to the step 710 of saving the cost optimization results, shown in FIG. 7A, which saves the latest cost value that satisfied an iterative loop break condition as well as the improved shipping method associated with the loop that generated that latest cost value. This stored improved shipping method is the optimal shipping method, as determined by the exemplary method 300. Although the disclosure has been described with a specific implementation of iterative analysis, other iterative analysis techniques that optimize the same parameters may be used to determine an optimal shipping method provided they meet the same functional and performance requirements discussed herein.

Referring to FIG. 7D, the step 750 (of the process of FIG. 7C) determines the improved (or more optimal) shipping method, beginning at a step 770 of grouping the trays by break-up method. Thus, if the break-up method (field 450 (FIG. 4)) is “by tray,” each tray will be its own group. If the break-up method is by pallet, all of the trays on a pallet will be considered to belong to the same group. If the break-up method is “by destination,” all the trays intended for a given destination entry location 22, 24, 26 will be considered to belong to the same group. If the break-up method is “by job,” each tray in a given job will be considered to belong to its own group. Then, a step 772 sums the total charges for each allowed transportation method for each group as defined by the break-up method. Then, a step 774 selects the most cost effective option for each group and marks (or flags) all trays in each group's grouping identification field of the CSM record(s) of each modified Mail.dat file 210 accordingly. If a tray's entry location is changed from the as-marked location contained in the Mail.dat file(s), the system 200 must consider the USPS labeling list files to ensure the trays are properly eligible for upgrade, for example, USPS file L801 for automated area distribution centers or USPS file L010 for mixed automated area distribution centers. When updating the CSM record(s), trays being marked for commingle includes updating the container grouping identification, postage grouping identification, label destination line 1 and 2, label contents line 1 and 2, and user information line 2. When updating CSM record(s), trays being marked for co-palletization includes updating the container grouping identification, postage grouping identification, label destination line 1 and 2, label contents line 1 and 2, user information line 2, scheduled induction date, scheduled pickup date, entry zip code/type/locale key, the co-palletization flag (or what may be a field in the Mail.dat file referred to as “included in other documentation,” which may be set to, for example, “O”, to indicate to the USPS that the current palletization will be altered by a third party). The marking of the trays in step 774 further includes updating the CQT record(s) to appropriately modify the entry level postage rate, for example, NDC postage rate or SCF postage rate, based on the determined qualified location the tray is selected to be deposited with. In addition, trays determined to be deposited with an AADC or mixed AADC are checked and updated (as needed) to ensure that the trays are correctly labeled in accordance with the USPS labeling list files (discussed above) so that the tray is eligible to be deposited at the upgraded USPS entry location. If the tray labels for trays designated for delivery to an AADC or mixed AADC do not have a matching USPS Labeling list record, then the system 200 may disregard these trays because they will not be eligible for co-palletization qualification. Otherwise, the process 750 proceeds as indicated in FIG. 7D.

As an example, if the break-up method entered was “by pallet,” and there were 1,000 pallets included in the imported via Mail.dat file(s) 208 then the step 706 during initializing the calculation starting point will initially mark all 1,000 pallets as being for consolidation. However, assuming consolidation, co-palletization and commingle services are all entered as permitted bulk mail services, then the step 772 will sum the total charges for consolidation, co-palletization and commingle services of each tray on a per pallet basis because the “by pallet” break-up method was selected. Then, the step 772 selects the most cost effective option for each group, in this case, for each pallet. Thus, for the first pallet of the 1,000 pallets, if consolidation total charges of the pallet is $350.00, and if co-palletization total charges of the pallet is $300.00 and if commingle total charges of the pallet is $425.00, then co-palletization would be selected for that first pallet and all trays in that group's group identification field of their corresponding CSM record would be marked accordingly. For example, in that case, the group identification field would be marked as “co-palletization.” However, for the second pallet of the 1,000 pallets, if consolidation charges were $325.00, co-palletization charges were $350.00 and commingle total charges were $375.00, then consolidation would be selected for that second pallet and all trays in that group would be marked accordingly. For example, in that case, the group identification field would be marked as “consolidation.” This process would continue for each group in the job, in this case for each pallet because the “by pallet” break-up method was selected. Thus, one possible outcome for a 1,000 pallet job would be that 825 pallets are selected for consolidation, 149 pallets are selected for co-palletization and 26 pallets are selected for commingle.

Referring to FIG. 4, as an example of results in the section 403 of the graphical user interface 400, assuming that the Mail.dat file 208 imported 302 (FIG. 3) into the system 200 for analysis with the method 300 according to the present disclosure contained 68,759 mail pieces with a net weight of 1,980 lbs and a gross weight of 2,484 lbs. As-marked in the Mail.dat file, there exists $1,717 drop-ship savings (“As-Marked Results” section 461) if the qualified mail pieces are drop shipped to destination entry locations 22, 24, 26 instead of being deposited local entry at the local entry post office 16. As-marked, 9,998 (14.5% of total mail pieces) of the mail pieces are to be deposited at “origin,” or in other words the local entry post office 16 while 58,761 (85.5% of total mail pieces) of the mail pieces are marked for consolidation services.

The pricing scenario for this example includes a consolidation charges and rate table 408, a co-palletization charges and rate table 410, and a $0.25 commingle rate per piece (RPP) 430 being stored in the system 200. Further, the selected MDC aggregation method 412 is by destination, the selected break-up method 450 is by pallet, and permitted bulk mailing services 455 includes consolidation, co-palletization and commingling. The shuttle rate 404 is $385 per shuttle with shuttles having a max weight 406 of 35,000 lbs and a fuel surcharge rate 407 is entered as 14% of shuttle costs. No preparation fees 405 or mark-up amounts 409 are entered.

The graphical user interface 400 shown in FIG. 4 is shown at a state after a user has activated the “analyze” button 414. Thus, the graphical user interface 400 is displaying the hybrid results in a section 470 as a result of a completed analysis according to the method 300 of the present disclosure. As a result of performing the method 300, the system 200 determined that an improved (or the optimal) shipping method that provides the greatest cost savings (optimal cost) consists of depositing none of the mail pieces (0%) field 471 via origin entry. Instead, 10,917 mail pieces (15.9% of the total mail pieces) field 472 are now marked for consolidation services and 57,842 mail pieces (84.1% of the total mail pieces) field 474 are now marked for co-palletization services. In this example, the system 200 determined that none of the mail pieces (0%) field 473 should be marked for commingle services. The graphical user interface 400 also shows a side-by-side comparison between as-marked charges in a section 480 and hybrid charges in section 490 for shuttle charges, inbound and outbound fuel surcharge rate, base charges (charges determined by consolidation and co-palletization charges and rate sheets) minimum destination charges, preparation fees, mark-ups and postage, as shown in section 492.

The drop ship savings (“DS Savings”) field 461 according to this improved shipping method amounts to $2,318 field 476, compared to the as-marked of $1,717 field 462. This drop ship savings is $602 greater than as originally marked (or “as-marked”). In other words, the hybrid savings as determined by the system 200 in accordance with the method 300 is $602 field 478. The hybrid results includes greater shipping charges fields 463 at $638 compared to the as-marked shipping charges of $473, however, this increase in shipping charges is overcome by the decrease in postage fields 465 now $15,689 compared to the as-marked $16,455. The breakdown of the as-marked postage, $16,455, is shown in field 495. The breakdown of the postage provides a visual summary of how much postage is spent on each type of USPS entry point facility, the number of mail pieces destined for each type of USPS entry point facility, the postage rate being paid for each mail piece per USPS entry point type and the rate type (e.g., 5-digit zip code rate, 3-digit zip code rate, MxAADC). Entry point type (or “EP Type”) may include letter codes to signify the type of USPS entry location. For example, the letter code “B” may refer to NDCs, the letter code “S” may refer to SCFs, and the letter code “N” may refer to none, or non-entry (i.e., origin entry). The decrease in postage is possible due to the USPS's postage policy for delivering bulk mailings deeper within the distribution network 14. In this example, the Mail.dat file 208 had 51,435 mail pieces marked for NDCs and 7,326 mail pieces marked for SCFs fields 466, 467 respectively. However, after analysis in accordance with the method 300, the system 200 has 6,920 mail pieces marked for NDCs and 61,839 mail pieces marked for SCFs. While field 495 is shown with the breakdown of the as-marked postage, it should be readily understood that this field may be configured to show alternatively to the breakdown of the as-marked postage, or in addition to, a breakdown of the hybrid postage.

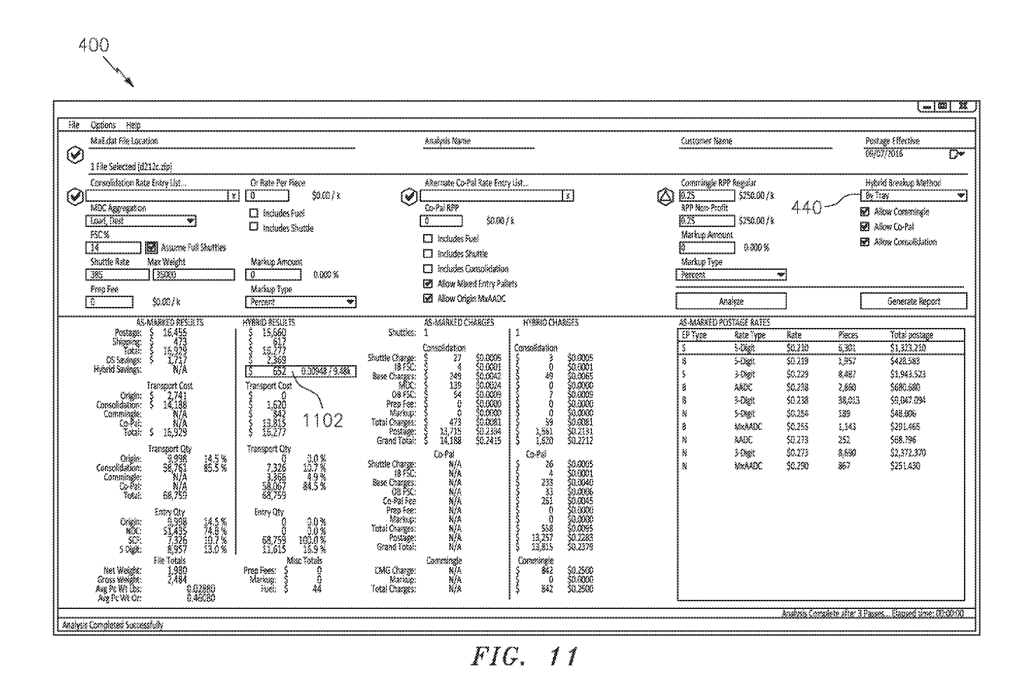

Referring to FIG. 11, in another example, the same Mail.dat file 208 and pricing scenario variables as described above in FIG. 4 are imported and stored into the system 200, except instead of selecting the break-up method as being “by pallet,” the selected break-up method is “by tray.” An exemplary graphical user interface shows the results determined by a system 200 performing the method 300 of the present disclosure on the same mail job as described in FIG. 4. However, in this scenario, because the “by tray” break-up method was selected, hybrid savings of $652 field 1102 are attained instead of $602 field 478 (FIG. 4). The net increase of $50 in hybrid savings is able to be achieved due to the analysis being performed on a “by tray” basis.

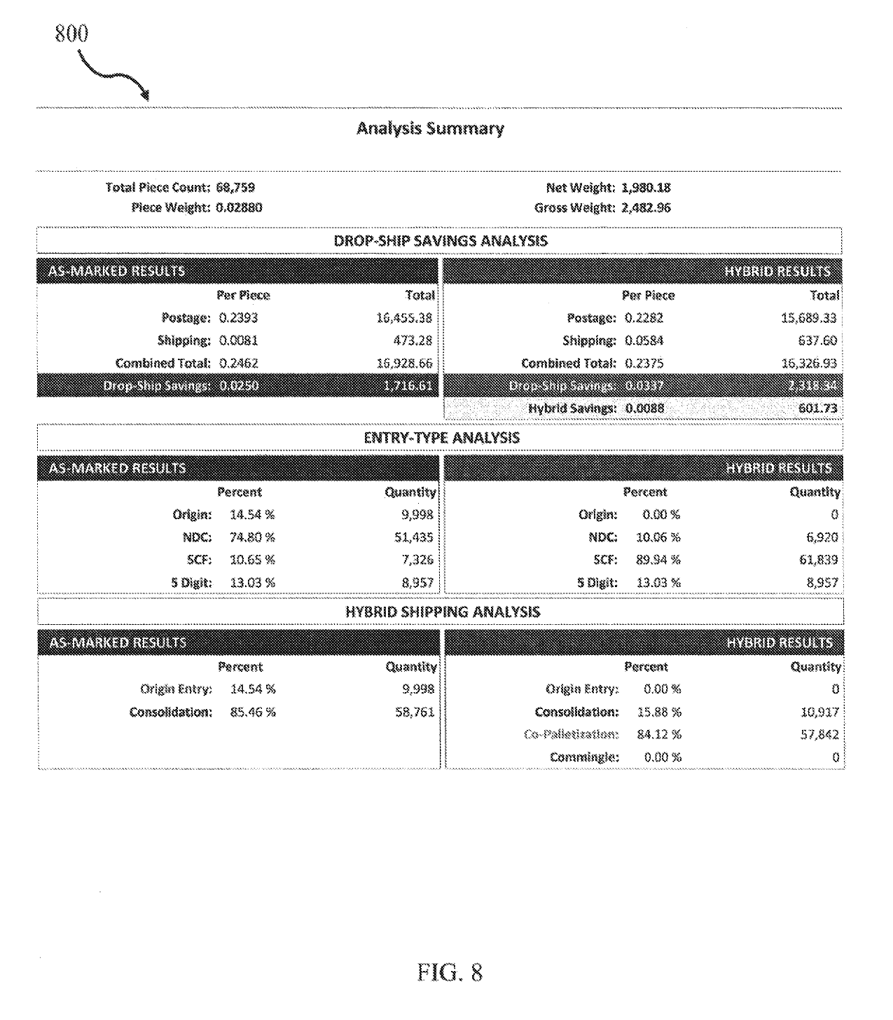

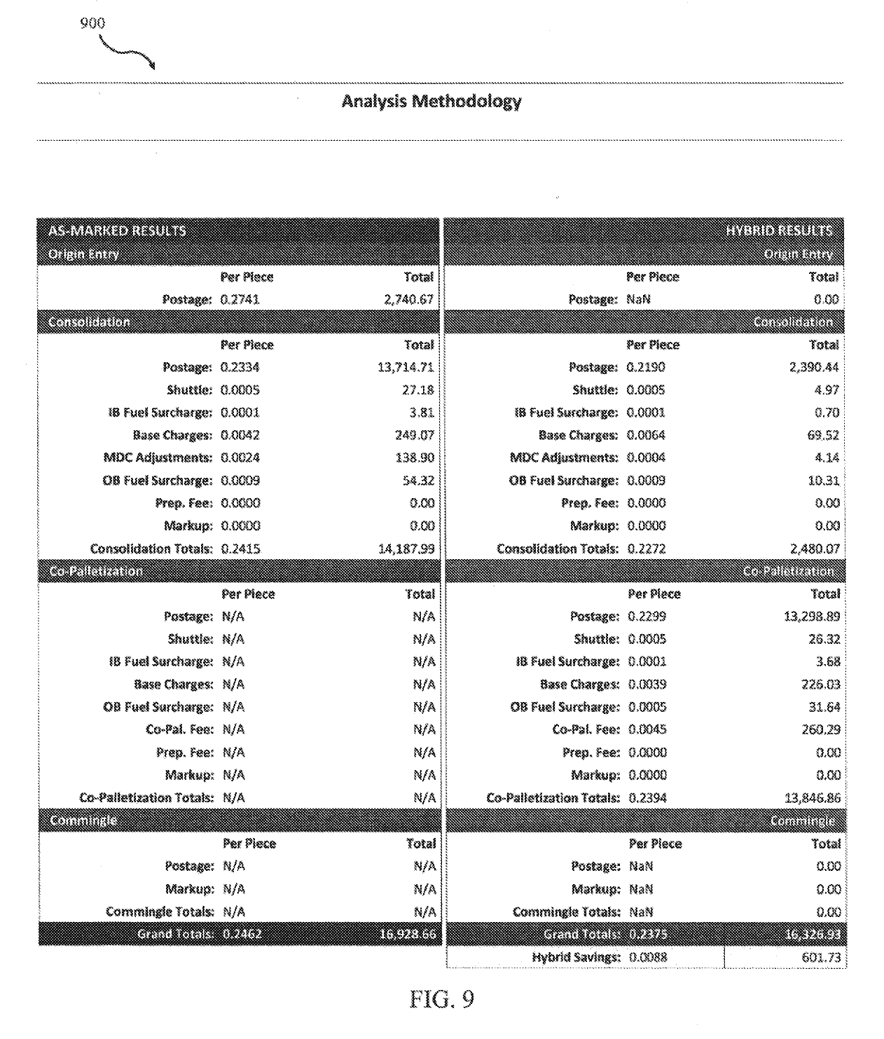

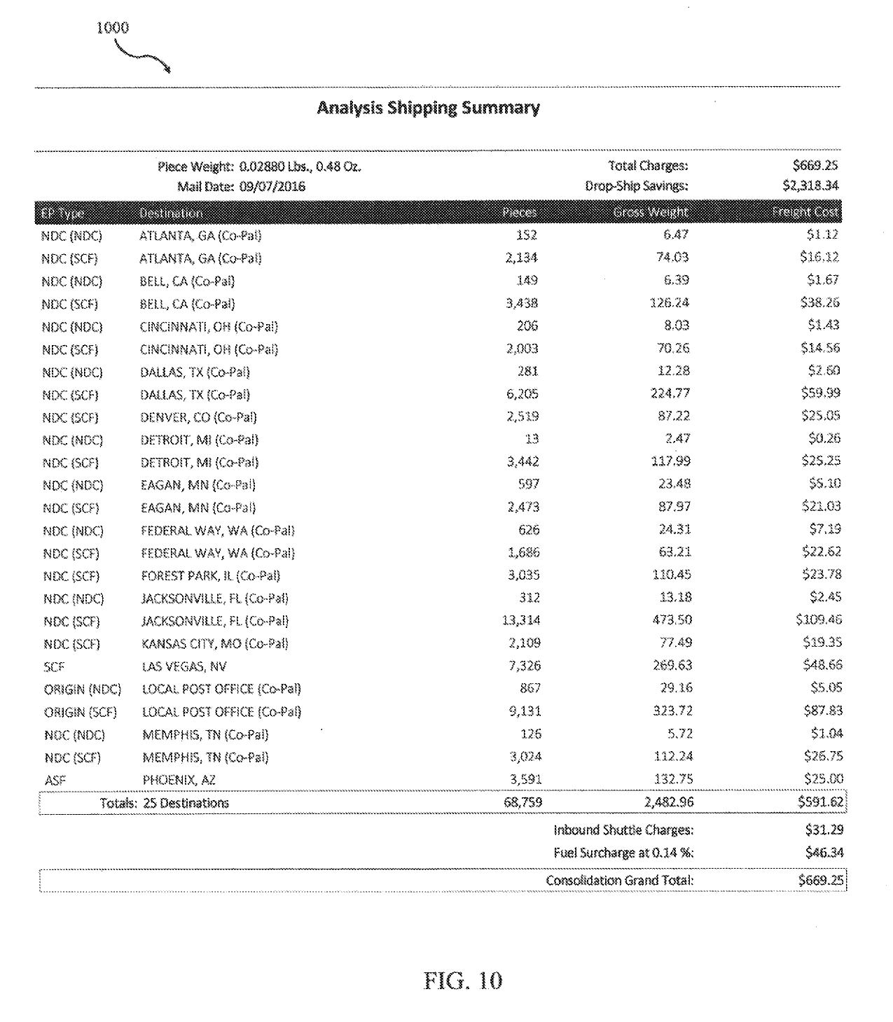

In some embodiments, the results may be formatted as shown in FIGS. 8-10. Referring to FIGS. 8-10, the generated reports 800, 900, 1000, respectively, may show a breakdown of the postage and other associated costs for each permitted bulk mailing service as determined for the optimal shipping method. The breakdown may in the form of table(s) and/or chart(s). The results/reports provided by the system 200 (FIG. 2) may include information showing the local entry costs for the job, the drop-ship costs and hybrid costs as determined by a method 300 according to embodiments of the present disclosure. The results may also include the drop-ship savings. The results may further include the savings from mailing the job by the optimal shipping method as determined by the method 300 of the present disclosure as opposed to local entry post office 16 and/or compared to drop-shipping, in other words, the hybrid savings. The results may further include a breakdown of cost associated with each destination.

Referring to FIG. 13, a detailed example illustrating the concept of qualification is shown. Pallet 1 is shown with having 25 trays being arranged thereon. Each tray contains a number of mail pieces 1302. A close-up view of Tray 1 (or a portion thereof) and its mail pieces 1302 is shown, where the mail pieces 1302 contained in the tray belong to different 3-digit zips, i.e., zip codes with differing first three digits. The mail pieces 1302 have addressed locations 28 (FIG. 1) to zip codes beginning with “012,” “345” and “678.” As shown, the 3-digit zip codes “012” and “345” are serviced by NDC1 and SCF1, while the mail pieces 1302 with the “678” 3-digit zip codes are serviced by NDC2 and SCF6. Therefore, Tray 1 is not qualified to be deposited with either of NDC1 22, NDC2 22, SCF1 24 or SCF6 24 because neither of those destination entry locations permit mail pieces having addressed locations 28 (FIG. 1) with zip codes outside of their defined geographic service area. Further, because Tray 1 is not qualified for NDC1 22, NDC2 22, SCF1 24 or SCF6 24, Pallet 1 is also not qualified to be deposited with NDC1 22, NDC2 22, SCF1 24 or SCF6 24. Thus, Pallet 1 would be as-marked for origin entry as it is not eligible for drop shipping.

While the exemplary method 300 has been described as receiving the pricing scenario 200 for each job, it is included within the scope of the present disclosure that the pricing scenario may already be preconfigured for a mailer 12. For instance, a pricing scenario may be preconfigured by the mailer 12 from a previous job and saved as a mailer 12 preference. This way the mailer 12 does not need to enter variables each time the mailer 12 desires to identify the optimized shipping method for a job when using a bulk mailing logistics method or apparatus according to the present disclosure. Alternatively, a vendor 30 or other provider may offer preconfigured pricing scenarios to mailers 12. Thus, the method in this instance would permit a mailer 12 to import Mail.dat file(s) 100 and directly proceed to performing hybrid analysis 300.

While FIG. 7B shows that certain steps for processing the Mail.dat file(s) 704 are performed in a certain order, it should be readily understood that embodiments according to the present disclosure may perform the steps in a different order. For instance, instead of performing the qualifying step 730 for all the trays for co-palletization at once and then performing the co-palletization rate and postage determining step 732, the method could include determining the co-palletization rate and postage after a tray has been qualified (the step 730) for co-palletization before proceeding to qualify (the step 730) the next tray in the Mail.dat file.

The present disclosure advantageously provides methods and systems for specifically identifying, contemporaneously with mailing jobs, which mail pieces in the mailing jobs are to receive either consolidation, co-palletization or commingling services in order to achieve greater mailing savings.

The present disclosure advantageously provides methods and systems that may be used before or after a mailer 12 has physically formed the pallets of a job. Thus, if a method according to the present disclosure is performed before the pallets are formed, the mailer 12 can avoid the time and expense of reorganizing pallets later. Yet, if a method according to the present disclosure is performed after the pallets are formed, the mailer 12 can still achieve cost savings by reconfiguring the pallets as provided for by the output of the cost optimization analysis results.

The present disclosure advantageously provides systems and methods that may generate modified Mail.dat files 210 that include a more efficient mail job logistics plan. The modified Mail.dat files 210 may be deposited with the USPS through the PostalOne!® system in substantially as generated by the disclosed systems 200 and methods 300. Alternatively, the mailer 12 or vendor 30 may further modify or alter the modified Mail.dat files 210 in order to alter the file(s) eventually deposited with the USPS. This may be advantageous if, for example, the mailer 12 is only going to send a portion of the mailing job to the USPS with or without the assistance of a vendor 30 and send the remaining part of the mail job to a commingler, in which case the commingler may separately deposit Mail.dat file(s) with the USPTO when that mail job is eventually executed.

While the term “mail job” is used in the present disclosure, persons of ordinary skill in the art may sometimes refer to “job” as a campaign, order, project or the like.

While GUIs, tables, reports and the like have been shown and described herein with specific values for costs, postage rates, shuttle weight, fuel surcharges, markup amounts and the like, it should be readily understood that the values shown and described herein are for illustrative purposes only. Embodiments according to the present disclosure may have the same and/or different values than the values provided herein for the above-mentioned items. Similarly, while values provided herein have been provided with specific units such as dollars ($), weight (lbs), percentages (%) and the like, it should be readily understood that the units shown and described herein are for illustrative purposes only. Embodiments according to the present disclosure may have the same and/or different units than the units provided herein for the above-mentioned items.

The system, computers, devices and the like described herein have the necessary electronics, computer processing power, interfaces, memory, hardware, software, firmware, logic/state machines, databases, microprocessors, communication links, displays or other visual or audio interfaces, printing devices, and any other input/output interfaces, to provide the functions or achieve the results described herein. Except as otherwise explicitly or implicitly indicated herein, process or method steps described herein may be implemented within software modules (or other computer programs) executed on one or more general purpose computers. Specially designed hardware may alternatively be used to perform certain operations. Accordingly, any of the methods described herein may be performed by hardware, software, or any combination of these approaches. In addition, a computer-readable storage medium may store thereon instructions that when executed by a machine (such as a computer) result in performance according to any of the embodiments described herein.

Any process descriptions, steps, or blocks in process or logic flow diagrams provided herein indicate one potential implementation, do not imply a fixed order, and alternate implementations are included within the scope of the present disclosure in which functions or steps may be deleted or performed out of order from that shown or described, including substantially concurrently or in reverse order, depending on the functionality involved, as would be understood by those reasonably skilled in the art.

Conditional language, such as, among others, “can,” “could,” “might,” or “may,” unless specifically stated otherwise, or otherwise understood within the context as used, is generally intended to convey that certain embodiments could include, but do not require, certain features, elements, or steps. Thus, such conditional language is not generally intended to imply that features, elements, or steps are in any way required for one or more embodiments or that one or more embodiments necessarily include logic for deciding, with or without user input or prompting, whether these features, elements, or steps are included or are to be performed in any particular embodiment.

Although exemplary embodiments of the present disclosure have been shown and described in detail, it will be understood by those skilled in the art that various changes in form and detail may be made without departing from the spirit and scope thereof. For example, although various charges have been described as being entered, for example, the shuttle charge, it would be within the scope of the present disclosure to not have any shuttle charges explicitly entered, but rather be incorporated into a different rate/charge. For example, commingle services may be offered with a flat rate per piece with no additional “shuttle charge.” However, one of ordinary skill would recognize that the shuttle charge is simply lumped in with the flat rate per piece charge. Accordingly, the preceding portion of this specification is to be taken in an illustrative, as opposed to limiting, sense.

What is claimed is:

1. A direct mail hybrid transportation allocation optimization system comprising:
a computer configured to perform the steps of:
receiving at least one as-marked mail data file associated with at least one direct mail delivery job having a plurality of mail pieces, wherein the at least one as-marked mail data file includes as-marked data identifying a plurality of United States Postal Service destination entry locations for the plurality of mail pieces, each mail piece having a corresponding tray and a corresponding pallet;
receiving a pricing scenario associated with transportation methods, including consolidation, co-palletization, and commingle;
performing hybrid transportation cost optimization, wherein the hybrid cost optimization includes determining an optimal shipping method having at least one of consolidation services, co-palletization services or commingle services; and
providing optimal transportation allocation data indicative of the optimal transportation allocation method determined by the performing hybrid transportation cost optimization step.

2. The system of claim 1, wherein the at least one as-marked mail data file comprises a Mail.dat file.

3. The system of claim 1, wherein the pricing scenario includes an inbound shuttle rate, a maximum weight per shuttle, a fuel surcharge rate, a consolidation charges and rate sheet, a consolidation preparation fee, a co-palletization charges and rate sheet, a minimum destination charge aggregation method, a commingle rate, a postage effective date, a transportation break-up method and/or a selection of which mail services are permitted by a mailer.

4. The system of claim 3, wherein the pricing scenario includes the consolidation charges and rate sheet, and wherein the consolidation charges and rate sheet includes applicable rates for performing consolidation services on mail pieces.

5. The system of claim 4, wherein the applicable rates for performing consolidation services on mail pieces includes rates for a plurality of United States Postal Service entry locations.

6. The system of claim 3, wherein the pricing scenario includes the co-palletization charges and rate sheet, and wherein the co-palletization charges and rate sheet includes applicable rates for performing co-palletization services on mail pieces.

7. The system of claim 6, wherein the applicable rates for performing co-palletization services on mail pieces includes rates for a plurality of United States Postal Service entry locations.

8. The system of claim 3, wherein the pricing scenario includes the minimum destination charge aggregation method, and wherein the minimum destination charge aggregation method is aggregated by shuttle/job/destination, by shuttle/destination, by destination or by pallet.

9. The system of claim 1, wherein the hybrid cost optimization is configured to be performed using iterative analysis based on the as-marked data and the pricing scenario.

10. The system of claim 9, wherein the iterative analysis includes an iterative loop break condition that causes the iterative analysis to stop when the iterative loop break condition is satisfied, and to provide the optimized transportation allocation data.

11. The system of claim 10, wherein the iterative loop break condition comprises two consecutively cost values being the same.

12. The system of claim 10, wherein the iterative loop break condition comprises any two cost values being the same.

13. The system of claim 9, wherein the computer calculates an initial starting point for the iterative analysis based on calculating the cost of performing consolidation services on all of the mail pieces contained in the at least one as-marked mail data file.

14. The system of claim 1, wherein the computer is configured to generate a report based on the determined optimal transportation allocation method.

15. A computer-based method for direct mail hybrid transportation allocation optimization, comprising:
receiving at least one “as-marked” mail data file associated with at least one mail job having a plurality of mail pieces, wherein the mail data file includes as-marked data identifying a plurality of United States Postal Service destination entry locations for the plurality of mail pieces, each mail piece having a corresponding tray and a corresponding pallet;
receiving a pricing scenario associated with transportation methods, including consolidation, co-palletization, and commingle;
performing a hybrid transportation cost optimization which includes an iterative analysis based on the as-marked data and the pricing scenario; and
generating a optimized transportation allocation data file, based on the hybrid cost optimization, wherein the optimized transportation allocation data file includes data identifying optimized transport allocation; including at least one of consolidation mail services, co-palletization mail services or commingle mail services for each mail piece, tray or pallet contained in the at least one mail file.

16. The method of claim 15, wherein the data included in the as-marked mail data file is text data, and the method further comprising generating data objects, based on the text data, in a database.

17. The method of claim 15, wherein the pricing scenario includes an inbound shuttle rate, a maximum weight per shuttle, a fuel surcharge rate, a consolidation charges and rate sheet, a consolidation preparation fee, a co-palletization charges and rate sheet, a minimum destination charge aggregation method, a commingle rate, a postage effective date, a transportation break-up method and/or a selection of which mail services are permitted by a mailer.

18. The method of claim 17, wherein the pricing scenario comprises the consolidation charges and rate sheet, and wherein the consolidation charges and rate sheet includes applicable rates for performing consolidation services on the mail pieces.

19. The method of claim 17, wherein the pricing scenario comprises the co-palletization charges and rate sheet, and wherein the co-palletization charges and rate sheet includes applicable rates for performing co-palletization services on the mail pieces.

20. The method of claim 17, wherein the iterative analysis includes an iterative loop break condition that causes the iterative analysis to stop when the iterative loop break condition is satisfied, and to provide the optimized transportation allocation data file.
